(19) United States
(12) Patent Application Publication
(10) Pub. No.: US 2024/0116506 A1
(43) Pub. Date: Apr. 11, 2024

(54) CONTROL CALCULATION APPARATUS AND CONTROL CALCULATION METHOD

(71) Applicant: Mitsubishi Electric Corporation, Tokyo (JP)

(72) Inventors: Kenta TOMINAGA, Tokyo (JP); Tomoki UNO, Tokyo (JP); Ryota OKAMOTO, Tokyo (JP)

(73) Assignee: Mitsubishi Electric Corporation, Tokyo (JP)

(21) Appl. No.: 18/276,505

(22) PCT Filed: Apr. 28, 2021
(86) PCT No.: PCT/JP2021/016923

§ 371 Date: Aug. 9, 2023

(51) Int. Cl. B60W 30/10

(52) U.S. Cl. CPC B60W 30/10

(57) ABSTRACT

An object is to provide a technique of suppressing increase in a calculation load by an elaborate vehicle model. A control calculation apparatus includes: a first trajectory generation unit generating a first trajectory of a vehicle in a first prediction period based on a first vehicle model and a first place; a second trajectory generation unit generating a second trajectory of the vehicle in a second prediction period based on a second vehicle model having a degree larger than a degree of the first vehicle model, a second place different from the first place, and the first trajectory; and a target value calculation unit calculating and outputting a target value based on the second trajectory.

### CROSS REFERENCE TO RELATED APPLICATIONS

This application is a National Stage of International Application No. PCT/JP2021/016923 filed on Apr. 28, 2021.

### TECHNICAL FIELD

The present disclosure relates to a control calculation apparatus and a control calculation method.

### BACKGROUND ART

Proposed is a control calculation apparatus automatically steering a subject vehicle to avoid an obstacle when the subject vehicle detects the obstacle located in a road in which the subject vehicle travels in order to achieve automatic driving or a semi-automatic driving partially including a manual driving of a driver.

For example, a control calculation apparatus in Patent Document 1 sets an evaluation function based on a position of an obstacle while predicting a future state of a subject vehicle for a certain period of time, and controls the subject vehicle to achieve a predicted travel trajectory optimizing an output value of the evaluation function, thereby making the subject vehicle avoid the obstacle. The output value of the evaluation function decreases as a distance from the subject vehicle to the obstacle and a distance from the subject vehicle to a road boundary increase or a difference between a predicted attitude angle and a target attitude angle of the subject vehicle after avoiding the obstacle decreases.

### PRIOR ART DOCUMENTS

### Patent Document(s)

Patent Document 1: Japanese Patent Application Laid-Open No. 2007-253745

### SUMMARY

### Problem to be Solved by the Invention

In a conventional control calculation apparatus, a trajectory is generated in consideration of various variables in as elaborate a vehicle model as possible. However, when the trajectory is generated in consideration of the various variables in only the elaborate vehicle model, calculation load increases, thus required is suppression of increase in the calculation load.

The present disclosure is therefore has been made to solve problems as described above, and it is an object of the present disclosure to provide a technique capable of suppressing increase in calculation load by an elaborate vehicle model.

### Means to Solve the Problem

A control calculation apparatus according to the present disclosure includes: a first place setting unit setting a first place where a vehicle does not travel based on peripheral information around the vehicle; a first trajectory generation unit generating a first trajectory of the vehicle in a first prediction period based on a first vehicle model expressing movement of the vehicle and the first place; a second place setting unit setting a second place, different from the first place, where the vehicle does not travel based on the peripheral information; a second trajectory generation unit generating a second trajectory of the vehicle in a second prediction period equal to or shorter than the first prediction period based on a second vehicle model expressing movement of the vehicle and having a degree larger than a degree of the first vehicle model, the second place, and the first trajectory; and a target value calculation unit calculating and outputting a target value for controlling the vehicle based on the second trajectory.

### Effects of the Invention

According to the present disclosure, the second trajectory of the vehicle in the second prediction period equal to or shorter than the first prediction period is generated based on the second vehicle model having the degree larger than the degree of the first vehicle mode., the second place, and the first trajectory, and the target value is calculated based on the second trajectory. Accordingly, increase in calculation load by an elaborate vehicle model can be suppressed.

These and other objects, features, aspects and advantages of the present disclosure will become more apparent from the following detailed description of the specification when taken in conjunction with the accompanying drawings.

### BRIEF DESCRIPTION OF DRAWINGS

FIG. 1 A block diagram illustrating an example of a control calculation apparatus according to an embodiment 1.

FIG. 2 A diagram illustrating an example of a subject vehicle according to the embodiment 1.

FIG. 3 A diagram illustrating an example of a coordinate system according to the embodiment 1.

FIG. 4 A flow chart illustrating an example of a procedure of automatic driving of the subject vehicle according to the embodiment 1.

FIG. 5 A flow chart illustrating an example of a procedure of a first trajectory generation according to the embodiment 1.

FIG. 6 A flow chart illustrating an example of a procedure of a second trajectory generation according to the embodiment 1.

FIG. 7 A diagram schematically illustrating an example of a relationship between a first place and a first path according to an embodiment 2.

FIG. 8 A diagram schematically illustrating an example of a relationship among the first path, a second place, and a second path according to the embodiment 2.

FIG. 9 A diagram schematically illustrating another example of a relationship between the first path, the second place, and the second path according to the embodiment 2.

FIG. 10 A diagram schematically illustrating an example of a relationship between a first place and a first path according to an embodiment 3.

FIG. 11 A diagram schematically illustrating an example of a relationship among the first path, a second place, and a second path according to the embodiment 3.

FIG. 12 A diagram schematically illustrating an example of a relationship between a first place and a first path according to an embodiment 4.

FIG. 13 A diagram schematically illustrating an example of a relationship among the first path, a second place, and a second path according to the embodiment 4.

FIG. 14 A diagram schematically illustrating an example of a relationship between a first place and a first path according to an embodiment 5.

FIG. 15 A diagram schematically illustrating an example of a relationship among the first path, a second place, and a second path according to the embodiment 5.

FIG. 16 A block diagram illustrating a hardware configuration of the control calculation apparatus according to another modification example.

FIG. 17 A block diagram illustrating a hardware configuration of the control calculation apparatus according to another modification example.

### DESCRIPTION OF EMBODIMENT(S)

### Embodiment 1

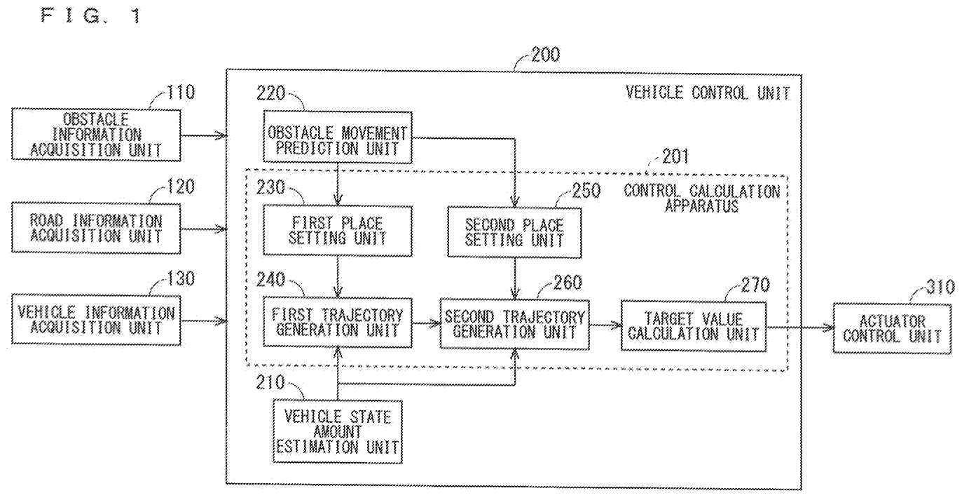

FIG. 1 is a block diagram illustrating an example of a control calculation apparatus 201 according to the present embodiment 1. A vehicle control unit 200 of a vehicle includes the control calculation apparatus 201 according to the present embodiment 1. In the description hereinafter, a vehicle provided with the control calculation apparatus 201 is also referred to as “subject vehicle” in some cases.

The control calculation apparatus 201 in FIG. 1 includes a first place setting unit 230, a first trajectory generation unit 240, a second place setting unit 250, a second trajectory generation unit 260, and a target value calculation unit 270. The vehicle control unit is a unit controlling the vehicle, and is mounted to an advanced driver assist system electrical control unit (ADAS-ECU), for example.

The first place setting unit 230 sets a first place as a place where a subject vehicle does not travel based on peripheral information around the subject vehicle. The peripheral information includes obstacle information as information including a position of an obstacle and road information as information including a boundary part of a road where the subject vehicle travels. Although described hereinafter, the obstacle information is acquired in an obstacle information acquisition unit 110, and the road information is acquired in the road information acquisition unit 120.

The place indicates a space such as a region or a potential field, for example. The first place setting unit 230 sets the first place including at least one of the obstacle and/or the boundary part based on the peripheral information including the obstacle information and the road information. The obstacle may be a pedestrian, an automobile, and the other vehicle around the subject vehicle, for example. The boundary part may be a compartment line, or may also be a curbstone, a gutter, and a guardrail, for example.

When the boundary part is the compartment line, the first place setting unit 230 needs to set the first place so that the subject vehicle does not travel outside a desired compartment line while avoiding the obstacle. However, when it is difficult to control the subject vehicle so that the subject vehicle does not travel outside the desired compartment line while avoiding the obstacle, the first place setting unit 230 sets the first place with priority on avoiding the obstacle, for example. In this case, the first place setting unit 230 may set the first place so that the subject vehicle can travel outside the desired compartment line. The same applies to a case where the second place setting unit 250 described hereinafter sets a second place.

The first trajectory generation unit 240 predicts a vehicle state amount of the subject vehicle over a future for a first prediction period based on a first vehicle model expressing movement of the subject vehicle, the first place, and the road information and generates the first trajectory on which the subject vehicle should travel. This prediction processing of the first trajectory is executed in a first execution period.

The second place setting unit 250 sets a second place as a place where the subject vehicle does not travel based on the peripheral information. That is to say, the second place setting unit 250 sets the second place including at least one of the obstacle and/or the boundary part based on the obstacle information and the road information. In the present embodiment 1, the second place may be the same as or different from the first place.

The second trajectory generation unit 260 predicts a vehicle state amount of the subject vehicle over a future for a second prediction period based on a second vehicle model expressing movement of the subject vehicle, the second place, and the first trajectory and generates the second trajectory on which the subject vehicle should travel. This prediction processing of the second trajectory is executed in a second execution period.

As described hereinafter, a degree of the second vehicle model is larger than that of the first vehicle model, and the second prediction period is shorter than the first prediction period. The degree corresponds to a type of a variable in a vehicle model, for example.

The target value calculation unit 270 calculates and obtains a target value for controlling at least steering of the subject vehicle based on the second trajectory, and outputs the target value to an outside of the control calculation apparatus 201 (herein, an actuator control unit 310). Herein, the target value is a target steering angle and a target acceleration rate, for example.

The vehicle control unit 200 uses the obstacle information acquisition unit 110, the road information acquisition unit 120, and a vehicle information acquisition unit 130 as an external input apparatus.

The obstacle information acquisition unit 110 is an acquisition unit acquiring obstacle information as information including a position of an obstacle. The obstacle information acquisition unit 110 may be a front camera, or may also be a light detection and ranging (LiDAR), a radar, a sonar, a vehicle-and-vehicle communication apparatus, and a road-and-vehicle communication apparatus, for example.

The road information acquisition unit 120 is an acquisition unit acquiring road information as information including a boundary part of a road where the subject vehicle travels. The road information acquisition unit 120 may be a front camera, or may also be a combination of a LiDAR and a map data processing apparatus or a combination of such as a global navigation satellite system (GNSS) and a map data processing apparatus, for example.

The vehicle information acquisition unit 130 is an acquisition unit acquiring vehicle information of the subject vehicle. The vehicle information acquisition unit 130 may be a steering angle sensor, a steering torque sensor, a yaw rate sensor, a velocity sensor, or an acceleration sensor, for example. The vehicle information is a current vehicle state amount of the subject vehicle, and is acquired using at least one of these sensors, for example.

A vehicle state amount estimation unit 210 and obstacle movement prediction unit 220 connected to the control calculation apparatus 201 are provided as constituent elements in the vehicle control unit 200. The vehicle state amount estimation unit 210 estimates the current vehicle state amount of the subject vehicle which is not acquired by the vehicle information acquisition unit 130 based on the vehicle information and the vehicle model. The vehicle state amount estimation unit 210 may estimate some of the vehicle information acquired by the vehicle information acquisition unit 130. The vehicle model used for estimation may be the first vehicle model or the second vehicle model, or the other vehicle model is also applicable. The obstacle movement prediction unit 220 predicts movement of the obstacle based on the obstacle information.

The control calculation apparatus 201 is connected to the actuator control unit 310 as an output apparatus outside the vehicle control unit 200. The actuator control unit 310 is a control unit controlling an actuator based on the target value calculated by the control calculation apparatus 201, and may be an electric power steering-electronic control unit (EPS-ECU), a power train ECU, a brake ECU, and an electric automobile ECU, for example. In the present embodiment 1, the vehicle control unit 200 performs steering control and vehicle speed control, and the actuator control unit 310 is made up of an EPS-ECU, a power train ECU, and a brake ECU, however, the configuration thereof is not limited thereto.

### <System Configuration Diagram>

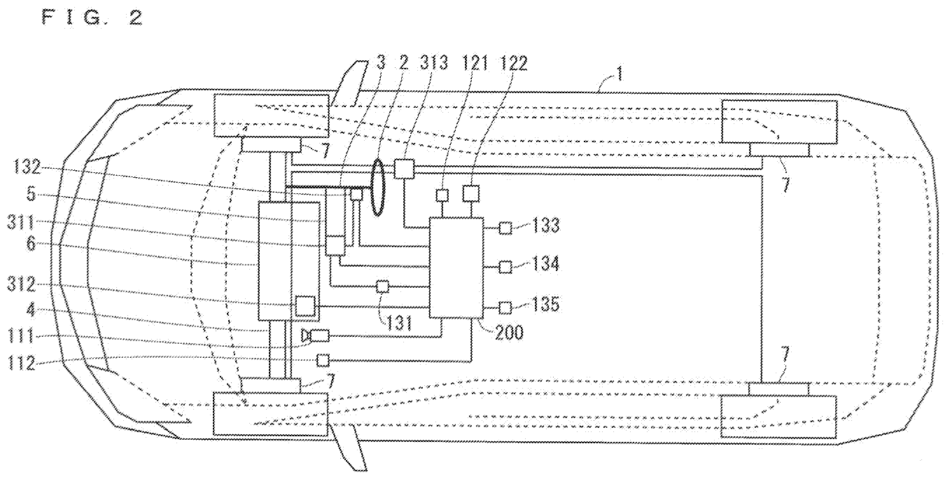

FIG. 2 is a diagram illustrating an example of a subject vehicle 1 provided with the control calculation apparatus 201 according to the present embodiment 1. The subject vehicle 1 includes a steering wheel 2, a steering shaft 3, a steering unit 4, an EPS motor 5, a power train unit 6, a brake unit 7, a front camera 111, a radar sensor 112, a GNSS 121, a navigation device 122, a steering angle sensor 131, a steering torque sensor 132, a yaw rate sensor 133, a velocity sensor 134, an acceleration sensor 135, the vehicle control unit 200, an EPS controller 311, a power train controller 312, and a brake controller 313. The EPS controller 311, the power train controller 312, and the brake controller 313 correspond to the actuator control unit 310 described above.

The steering wheel 2 for the driver to operate the subject vehicle 1 is joined to the steering shaft 3. The steering unit 4 is connected to the steering shaft 3. The steering unit 4 rotatably supports a front wheel as a steering wheel and is steerably supported by a vehicle body frame. Accordingly, a torque generated when the driver operates the steering wheel 2 rotates the steering shaft 3 and the front wheel is steered in a right-left direction by the steering unit 4. Accordingly, the driver can operate a lateral movement amount of the subject vehicle 1 at a time when the subject vehicle 1 travels forward and backward. The steering shaft 3 can be rotated by the EPS motor 5, and the EPS controller 311 controls current flowing in the EPS motor 5, thereby being able to steer the front wheel independently from the operation of the steering wheel 2 by the driver.

The vehicle control unit 200 is an integrated circuit such as a microprocessor, and includes an A/D conversion circuit, a D/A conversion circuit, a central processing unit (CPU), a read only memory (ROM), and a random access memory (RAM), for example. The vehicle control unit 200 is connected to the front camera 111, the radar sensor 112, the GNSS 121, the navigation device 122, the steering angle sensor 131 detecting a steering angle, the steering torque sensor 132 detecting a steering torque, the yaw rate sensor 133 detecting a yaw rate, the velocity sensor 134 detecting a velocity of the subject vehicle 1, the acceleration sensor 135 detecting an acceleration of the subject vehicle 1, the EPS controller 311, the power train controller 312, and the brake controller 313.

The vehicle control unit 200 processes information inputted from a sensor, for example, in accordance with a program stored in the ROM, transmits the target steering angle to the EPS controller 311, and transmits the target acceleration to the power train controller 312 and the brake controller 313. When the subject vehicle 1 is a vehicle which is not automatically driven but is manually driven, the vehicle control unit 200 and the power train controller 312 are not connected to each other, and the vehicle control unit 200 and the brake controller 313 are not connected to each other.

The front camera 111 is disposed in a position where a compartment line in front of the subject vehicle 1 can be detected as an image to detect a front side environment of the subject vehicle 1 such as traffic lane information and obstacle information based on image information. Described in the present embodiment 1 is an example that only the camera detecting the front side environment of the subject vehicle 1 is disposed, however, a camera detecting a back side or lateral side environment of the subject vehicle 1 may also be disposed.

The radar sensor 112 emits radar and detects reflective waves thereof, thereby outputting a relative distance and a relative speed between the subject vehicle 1 and an obstacle of the subject vehicle 1. Applicable as the radar sensor 112 is a known system such as a millimeter wave radar, a LiDAR, a laser range finder, and an ultrasonic radar.

The GNSS 121 receives radio waves from a positioning satellite by an antenna, and performs positioning calculation, thereby outputting an absolute position and an absolute orientation of the subject vehicle 1.

The navigation device 122 has a function of calculating an optimal travel route to a destination set by the driver and a function of recording road information on the travel route. The road information includes plural pieces of map node data expressing a road alignment, and information of an absolute position (latitude, longitude, altitude), a traffic lane width, a cant angle, an inclination angle in each node, for example, is incorporated into each map node data.

The EPS controller 311 controls the EPS motor 5 based on the target steering angle transmitted from the vehicle control unit 200.

The power train controller 312 controls the power train unit 6 based on the target acceleration transmitted from the vehicle control unit 200. When the driver performs velocity control, the power train controller 312 controls the power train unit 6 based on an amount of depressing an acceleration pedal. Described in the present embodiment 1 is an example that the subject vehicle 1 is a vehicle having only an engine as a drive source, however, also applicable is a vehicle having only an electric motor as a drive source or a vehicle having both an engine and an electric motor as a drive source.

The brake controller 313 controls the brake unit 7 based on the target acceleration transmitted from the vehicle control unit 200. When the driver performs velocity control, the brake controller 313 controls the brake unit 7 based on an amount of depressing a brake pedal.

### <Coordinate System>

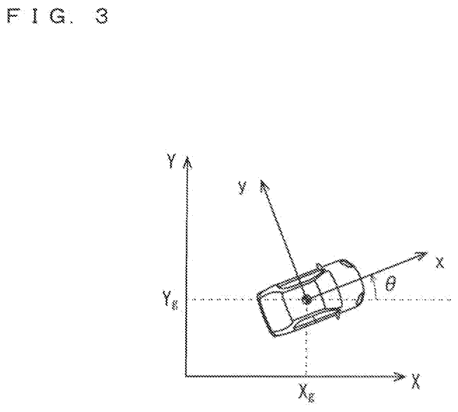

FIG. 3 is a diagram illustrating an example of a coordinate system according to the present embodiment 1. In FIG. 3, X and Y express an inertial coordinate system, and X_{g}, Y_{g}, and θ express a gravity position and a vehicle body orientation of the subject vehicle in the inertial coordinate system. x and y are a subject vehicle coordinate system in which a gravity of the subject vehicle is an origin point, and an x axis is located in front of the subject vehicle, and a y axis is located in a left side direction. In the present embodiment 1, values of gravity positions X_{g} and Y_{g} of the subject vehicle and the vehicle body orientation θ are initialized to 0 every first execution period and second execution period. That is to say, the inertial coordinate system and the subject vehicle coordinate system are made to coincide with each other every first execution period and second execution period.

### <Setting of Optimization Problem>

In the present embodiment 1, the first trajectory generation unit 240 and the second trajectory generation unit 260 solve an optimization problem obtaining a control input u minimizing an evaluation function J expressing a desired operation of the subject vehicle under a constraint g. The first trajectory generation unit 240 and the second trajectory generation unit 260 predict an optimized vehicle state amount from a current time θ to a future in a prediction period Tₕ at a prediction interval Tₛ based on the control input u obtained from the optimization problem and the vehicle model f mathematically expressing movement of the subject vehicle. In the description hereinafter, a time from the current time to Tₕ is abbreviated as a horizon in some cases.

The first trajectory generation unit 240 and the second trajectory generation unit 260 generate a trajectory ξ as series data including the position of the subject vehicle from the optimized vehicle state amount. This generation of the trajectory ξ is executed every constant execution period Tₑ. Each of the vehicle model f, the constraint g, the evaluation value J, the prediction interval Tₛ, the prediction period Tₕ, and the execution period Tₑ may be different between the first trajectory generation unit 240 and the second trajectory generation unit 260.

In the description hereinafter, when these variables are explicitly distinguished between the first trajectory generation unit 240 and the second trajectory generation unit 260, these are referred to as a first vehicle model f₁ and a second prediction interval T_{s, 2}, for example. The series data including the position of the subject vehicle is referred to as a trajectory ξ, and the series data of only the position of the subject vehicle is referred to as a path χ.

In the present embodiment 1, a degree of the second vehicle model f₂ is larger than that of the first vehicle model f₁. According to such a configuration, the trajectory is generated from the elaborate second vehicle model f₂ based on the trajectory generated from the simple first vehicle model f₁, thus calculation load by the elaborate second vehicle model f₂ can be reduced.

In the present embodiment 1, the second prediction period T_{h, 2} is smaller than the first prediction period T_{h, 1}. Thus, a long-period trajectory can be generated from the simple first vehicle model f₁, and a short-period trajectory can be generated from the elaborate second vehicle model f₂. Herein, the first trajectory is the long-period trajectory, and thus is smooth, however, it is generated by the simple first vehicle model, thus is unsuitable for usage in calculation of the target value. However, the second trajectory is generated from the elaborate second vehicle model, thus is appropriate for usage in calculation of the target value. The second trajectory is the short-period trajectory, but is generated based on the first trajectory, thus smoothness in the second trajectory is ensured.

To summarize the above description, according to the present embodiment 1, both generation of the smooth trajectory along which the subject vehicle can smoothly travel and elaborate control of the subject vehicle can be achieved while suppressing increase in the calculation load.

When the first prediction period T_{h, 1} is a product of the number of prediction points N₁ and the first prediction interval T_{s, 1} and when the second prediction period T_{h, 2} is a product of the number of prediction points N₂ and the second prediction interval T_{s, 2}, the number of prediction points N₁ and N₂ may be the same as each other and constant. Accordingly, even when the prediction period increases, increase in the calculation load can be suppressed.

In the present embodiment 1, it is important to suppress increase in the calculation load caused by generating the second trajectory. The calculation load depends on the degree of the vehicle model and the number of prediction points N (obtained by dividing the prediction period Tₕ by the prediction interval Tₛ). As an example, set as parameters in generating the first trajectory are the first prediction period T_{h, 1}=5.0 [sec], the first prediction interval T_{s, 1}=0.1 [sec], the first number of prediction points N₁=50 [point], and a degree of first vehicle model =5. In the similar manner, set as parameters in generating the second trajectory are the second prediction period T_{h, 2}=2.0 [sec], the second prediction interval T_{s, 2}=0.1 [sec], the second number of prediction points N₂=20 [point], and a degree of second vehicle model =10. If there is no first trajectory generation unit 240 but only the second trajectory generation unit 260 is applied, both a parameter in generating the first trajectory and a parameter in generating the second trajectory described above need to be considered to achieve accurate and smooth control of the subject vehicle. That is to say, the second prediction period T_{h, 2}=6.0 [sec], the second prediction interval T_{s, 2}=0.1 [sec], the second number of prediction points N₂=60 [point], and a degree of second vehicle model =10 need to be set. However, in the present embodiment 1, generation of the first trajectory and generation of the second trajectory are applied, thus the second number of prediction points N₂ can be reduced to 20 [point] as described above. As a result, increase in the calculation load caused by generating the second trajectory can be reduced as much as possible. In the example described above, the first prediction interval T_{s, 1} and the second prediction interval T_{s, 2} are set to have the same value of 0.1 [sec], however, the second prediction interval T_{s, 2} may be smaller than the first prediction interval T_{s, 1}. Accordingly, a time resolution at a time of generating the second trajectory is increased, and the more elaborate vehicle control can be achieved. However, the second prediction interval T_{s, 2} is preferably set so that the second number of prediction points N₂ is not larger than the first number of prediction points N₁ as much as possible.

The second execution period T_{e, 2} of generating the second trajectory may be set to be equal to or shorter than the first execution period T_{e, 1} of generating the first trajectory. Accordingly, the second trajectory generation unit 260 having direct influence on the target value of the subject vehicle can be executed with a high frequency while ensuring a calculation time in the first trajectory generation unit 240 for generating the long-period trajectory, thus both generation of the smooth trajectory and elaborate control of the subject vehicle can be achieved.

According to the above description, the parameter in generating the first trajectory and the parameter in generating the second trajectory are preferably set to satisfy the first prediction period T_{h, 1}>the second prediction period T_{h, 2}, the first prediction interval T_{s, 1}≥the second prediction interval T_{s, 2}, and the first execution period T_{e, 1}≥the second execution period T_{e, 2}.

### <Formulation of Optimization Problem>

As described above, in the present embodiment 1, the first trajectory generation unit 240 and the second trajectory generation unit 260 solve the optimization problem with constraint every certain period of time. The optimization problem is formulated as the following expressions.

$${min}_{u} J \qquad ( EXPRESSION 101 )$$

$$\begin{matrix}s . t . & \dot{x} = f ( x , u )\end{matrix} \qquad ( EXPRESSION 102 )$$

$${x}_{0} = x ( 0 )$$

$$ℊ ( x , u ) \leq 0$$

Herein, J is an evaluation function, x is a vehicle state amount, u is a control input, fis a vector value function regarding a dynamic vehicle model, and x₀ is an initial value of a vehicle state amount, that is to say, a current vehicle state amount. g is a vector value function regarding a constraint, and is a function for setting upper-lower limit values of the vehicle state amount x and the control input u in the optimization problem with constraint. Optimization of minimizing the evaluation function J is executed under constraint of g (x, u)≤0. In the present embodiment 1, the optimization problem described above is treated as a minimization problem, but may also be treated as a maximization problem by inverting a sign of the evaluation function J.

In the present embodiment 1, the following expression is used for the evaluation function J.

J=(h_{N}(x_{N})−r_{N}^{T}W_{N}(x_{N})+Σₖ₌₀^{N-1}(h(xₖ, uₖ)−rₖ)^{T}W(h(xₖ, uₖ)−rₖ) (EXPRESSION 103)

Herein, xₖ is a vehicle state amount in a prediction point (k=0, . . . , N), and uₖ is a control input in a prediction point k (k=0, . . . , N−1). h is a vehicle value function regarding an evaluation item, and hn is a vector value function regarding an evaluation item in a terminal end (the number of prediction points N), and rₖ is a reference value in a prediction point k (k=0, . . . , N). Each of W and W_{N} is a weighing matrix and a diagonal matrix having weighting on each evaluation item in a diagonal component, and can be appropriately changed as a parameter of the evaluation function J.

### <Vehicle Model>

In the present embodiment 1, a first vehicle state amount x₁ and a first control input u used in the first trajectory generation unit 240 are set as the following expressions. function J.

x₁=[X_{g}, Y_{g}, θ, V, δ]^{T} (EXPRESSION 104)

u₁=[α, ω]^{T} (EXPRESSION 105)

Herein, X_{g} and Y_{g} are gravity positions of the subject vehicle in FIG. 3, V is a vehicle speed, δ is a steering angle, a is an acceleration, and ω is a steering speed. As long as the first vehicle state amount x₁ includes a variable regarding a position, the first vehicle state amount x₁ and the first control input ui may be set in any way. The variable of the position is not limited to a rectangular coordinate system, but may be defined by a path coordinate system, and a variable regarding the position may not be a gravity position.

A geometric model indicated in the following expression is used for the first vehicle model f₁ in consideration of an expression 101.

$${\dot{x}}_{1} = [ \begin{matrix}V cos ( θ + β ) \\ V sin ( θ + β ) \\ γ \\ α \\ ω\end{matrix} ] \qquad ( EXPRESSION 106 )$$

Herein, β is a sideslip angle, γ is a yaw rate, and they are expressed by the following expression in the first trajectory generation unit 240.

$$β = {tan}^{- 1} ( \frac{{l}_{r}}{l} tan δ ) \qquad ( EXPRESSION 107 )$$

$$γ = \frac{V}{{l}_{r}} sin β \qquad ( EXPRESSION 108 )$$

Herein, l_{f} and lᵣ are distances from a front wheel axis and rear wheel axis to the vehicle gravity, respectively, and 1=If +1, is established. A vehicle model other than the geometric model may be applied to the first vehicle model f₁.

In the present embodiment 1, a second vehicle state amount x₂ and a second control input u₂ used in the second trajectory generation unit 260 are set as the following expressions.

x₂=[X_{g}, Y_{g}, θ, β, γ, V, α, αₜ, δ, δₜ]^{T} (EXPRESSION 109)

u₂=[jₜ, ωₜ]^{T} (EXPRESSION 110)

Herein, at is a target acceleration and δₜ is a target steering angle, and both of them are inputted to the actuator control unit 310. jₜ is a target jerk, and ωₜ is a target steering angle velocity. As long as the second vehicle state amount x₂ includes a variable regarding a position and one of the second vehicle state amount x₂ and the second control input u₂ includes a variable regarding a steering and a vehicle speed, the second vehicle state amount x₂ and the second control input u₂ may be set in any way. The variable of the position is not limited to a rectangular coordinate system, but may be defined by a path coordinate system, and a variable regarding the position may not be a gravity position. When the control calculation apparatus 201 performs only the steering control, the second vehicle state amount x₂ and the second control input u₂ may be set in any way as long as the second vehicle state amount x₂ includes a variable regarding a position and one of the second vehicle state amount x₂ and the second control input u₂ includes a variable regarding a steering.

A two-wheel model indicated in the following expression is used for the second vehicle model f₂ in consideration of an expression 101.

$${\dot{x}}_{2} = [ \begin{matrix}V cos ( θ + β ) \\ V sin ( θ + β ) \\ γ \\ - γ + \frac{2}{MV} ( {Y}_{f} + {Y}_{r} ) \\ \frac{2}{I} ( {l}_{f} {Y}_{f} - {l}_{r} {Y}_{r} ) \\ a \\ \frac{{a}_{t} - a}{{T}_{a}} \\ {j}_{t} \\ \frac{{δ}_{t} - δ}{{T}_{δ}} \\ {ω}_{t}\end{matrix} ] \qquad ( EXPRESSION 111 )$$

Herein, M is a vehicle mass, and I is a yaw inertia moment of a vehicle. Tₐ and T₆₇ are time constants in a case where followability to an indication of an acceleration and steering angle is expressed by a first order lag series. Y_{f} and Yᵣ are cornering force of front and rear wheels, respectively, and are expressed by the following expressions using cornering stiffness C_{f} and Cᵣ of the front and rear wheels.

$${Y}_{f} = - {C}_{f} ( β + \frac{{l}_{f}}{V} γ - δ ) \qquad ( EXPRESSION 112 )$$

$${Y}_{r} = - {C}_{r} ( β - \frac{{l}_{r}}{V} γ ) \qquad ( EXPRESSION 113 )$$

A vehicle model other than the two-wheel model may be applied to the second vehicle model f₂. For example, an elaborate two-wheel model needs not necessarily be used in a straight road with no obstacle, thus a vehicle model having a degree larger than a degree of the vehicle model in the expression 106 and smaller than the vehicle model in the expression 111 may be used for the second vehicle model f₂. In a configuration that the second trajectory generation unit 260 selects the vehicle model in accordance with a state of the road, there may be a case where increase in the calculation load can be further suppressed. Herein, the state of the road is a curvature of a road acquired by the road information acquisition unit 120, for example. The second trajectory generation unit 260 may change the degree of the vehicle model in accordance with the state of the road.

### <Procedure of Control Calculation Apparatus>

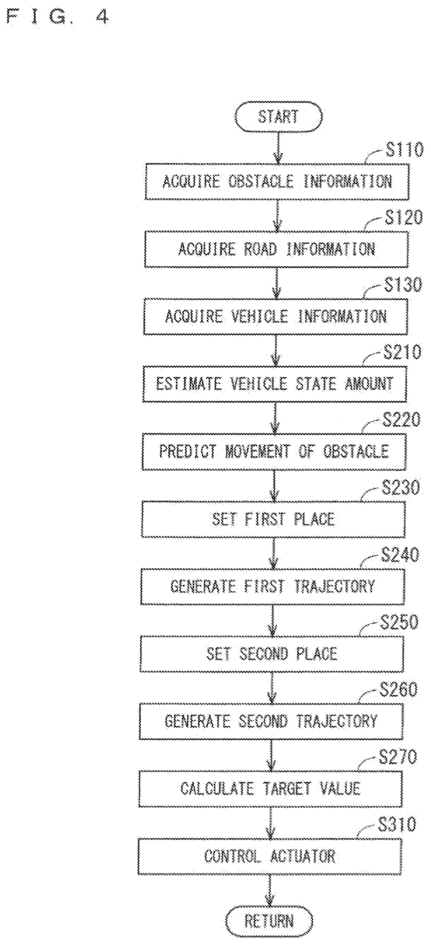

FIG. 4 is a flow chart illustrating an example of a procedure of automatic driving of the subject vehicle according to the present embodiment 1.

In Step S110 in FIG. 4, the obstacle information acquisition unit 110 acquires the obstacle information. The obstacle information is information including the position of the obstacle. In the present embodiment 1, when the obstacle is located on a front left side of the subject vehicle, the obstacle information includes positions of a right front end P_{FR}, a right back end P_{RR}, and a left back end P_{RL} of the obstacle in the subject vehicle coordinate system, and when the obstacle is located on a front right side of the subject vehicle, the obstacle information includes positions of a left front end P_{FL}, a left back end P_{RL}, and a right back end P_{RR} of the obstacle in the subject vehicle coordinate system. The obstacle information acquisition unit 110 estimates the position of the left front end P_{FL} or right front end P_{FR} of the obstacle, positions Xₒ and Yₒ of a center P_{C}, a vehicle body orientation θₒ, a velocity Vₒ, a length lₒ, and a width wₒ based on the positional information thereof. In Step S120 in FIG. 4, the road information acquisition unit 120 acquires the road

information. The road information is information including a boundary part of the road where the subject vehicle travels, and is information including a coefficient at a time of expressing right and left compartment lines by a third-order polynomial in the present embodiment 1. That is to say, the road information acquisition unit 120 acquires values of Cₗ₀ to cₗ₃ in the expression 201 for the left compartment line, and acquires values of cᵣ₀ to Cᵣ₃ in the expression 202 for the right compartment line.

Y=cₗ₃X³+cₗ₂X²+cₗ₁X+cₗ₀ (EXPRESSION 201)

Y=cᵣ₃X³+cᵣ₂X²+cᵣ₁X+cᵣ₀ (EXPRESSION 202)

At this time, a center of the traffic lane is expressed by the following expression.

Y=l(X)=c_{c3}X³+c_{c2}X²+c_{c1}X+c_{c0} (EXPRESSION 203)

c_{C0} to c_{C3} in this expression is expressed by the following expression.

$${C}_{ci} = \frac{( {c}_{li} + {c}_{ri} )}{2} ( i = 0 , … , 3 ) \qquad ( EXPRESSION 204 )$$

The information of the compartment line is not limited to the third-order polynomial as described above, but may also be expressed by any function.

In Step S130 in FIG. 4, the vehicle information acquisition unit 130 acquires the vehicle information as a current vehicle state amount of the subject vehicle. The vehicle information is information of the vehicle state amount x itself such as the steering angle, yaw rate, velocity, and acceleration of the subject vehicle or information for estimating the vehicle state amount x, and in the present embodiment 1, the vehicle information includes the steering angle δ, the yaw rate γ, the velocity V, and the acceleration a.

Next, in Step S210 in FIG. 4, the vehicle state amount estimation unit 210 estimates the current vehicle state amount x of the subject vehicle based on the vehicle information acquired by the vehicle information acquisition unit 130. Used for estimating the vehicle state amount x is a known technique such as a low-pass filter, an observer, Kalman filter, and a particle filter, for example.

Next, in Step S220 in FIG. 4, the obstacle movement prediction unit 220 predicts movement of the obstacle based on the obstacle information acquired by the obstacle information acquisition unit 110. In the movement prediction, a center position X_{o, k} and Y_{o, k} of the obstacle, the vehicle body orientations θ_{o, k}, and velocity V_{o, k} are predicted based on each prediction point k (k=0, . . . , N₁). In the present embodiment 1, the obstacle movement prediction unit 220 approximates the movement of the obstacle as uniform linear motion, and estimates the center positions X_{o, k} and Y_{o, k} of the obstacle, the vehicle body orientations θ_{o, k}, and the velocity V_{o, k} in the prediction point k (k=0, . . . , N₁) as the following expressions.

X_{o,k}=X_{o,k-1}+V_{o,k-1} cos (θ_{o,k-1})·Tₛ·k (EXPRESSION 205)

Y_{o,k}=Y_{o,k-1}+V_{o,k-1} sin (θ_{o,k-1})·Tₛ·k (EXPRESSION 206)

θ_{o,k}=θ_{o,k-1} (EXPRESSION 207)

V_{o,k}=V_{o,k-1} (EXPRESSION 208)

Each of X_{o, 0}, Y_{o, 0}, θ_{o, 0}, V_{o, 0} is a center position, a vehicle body orientation, and a speed of the obstacle at a current time acquired by the obstacle information acquisition unit 110. When the plurality of obstacles are located, the prediction described above is performed on each obstacle. The obstacle movement prediction unit 220 may perform the movement prediction of the obstacle moving at a constant speed along a driving lane instead of the uniform linear motion. The obstacle movement prediction unit 220 may predict movement of the obstacle using a driver model.

In Step S230 in FIG. 4, the first place setting unit 230 sets a first place S₁ based on the obstacle information acquired by the obstacle information acquisition unit 110 and the road information acquired by the road information acquisition unit 120. For example, the first place setting unit 230 sets an oval no-entry region in the center position X_{o, k} and Y_{o, k} of the obstacle in each prediction point k (k=0, . . . , N₁) as the first place S1. An equation (X, Y)=0 of the oval expressing the no-entry region is expressed by the following expression.

$$ζ ( X , Y ) = 1 - \{ {( \frac{( X - {X}_{o , k} ) \cdot cos {θ}_{o , k} + ( Y - {Y}_{o , k} ) \cdot sin {θ}_{o , k}}{{l}_{a}} )}^{2} + {( \frac{- ( X - {X}_{o , k} ) \cdot sin {θ}_{o , k} + ( Y - {Y}_{o , k} ) \cdot cos {θ}_{o , k}}{{l}_{b}} )}^{2} \} = 0 \qquad ( EXPRESSION 209 )$$

lₐ and l_{b} are lengths of a long axis and short axis of the oval set for the obstacle, respectively, and may be changed for each prediction point k. The center of the oval needs not coincide with the center position X_{o, k} and Y_{o, k} of the obstacle. The no-entry region set in the obstacle needs not have the oval shape, however, a no-entry region having an optional shape may be set. When the plurality of obstacles are located, the first place setting unit 230 sets the no-entry region for each obstacle.

In Step S240 in FIG. 4, the first trajectory generation unit 240 generates a first trajectory ξ₁ based on the first vehicle model f₁, the first place S₁, the first evaluation function J₁, the first constraint g₁, the road information, and the first vehicle state amount x₁. The process in Step S240 is described in detail hereinafter.

In Step S250 in FIG. 4, the second place setting unit 250 sets a second place S2

based on the obstacle information acquired by the obstacle information acquisition unit 110 and the road information acquired by the road information acquisition unit 120. For example, the second place setting unit 250 sets an oval no-entry region acquired by applying the expression 209 to the central position Xo, k, Y_{o, k} of the obstacle in each prediction point k (k=0, . . . , N₂) as the second place S₂ in the manner similar to the first place setting unit 230. The lengths lₐ and l_{b} of the long axis and short axis of the oval in the second place S₂ may be different from those set in the first place S₁. The no-entry region set in the obstacle needs not have the oval shape, however, a no-entry region having an optional shape may be set. When the plurality of obstacles are located, the second place setting unit 250 sets the no-entry region for each obstacle.

In Step S260 in FIG. 4, the second trajectory generation unit 260 generates a second trajectory ξ₂ based on the second vehicle model f₂, the second place S₂, the second evaluation function J₂, the second constraint g₂, the first trajectory ξ₁, and the second vehicle state amount x₂. The process in Step S260 is described in detail hereinafter.

In Step S270 in FIG. 4, the target value calculation unit 270 calculates a target value based on the second trajectory ξ₂. In the present embodiment 1, the steering control and the vehicle speed control are performed, and the target value calculation unit 270 calculates a target steering angle dt as a target value regarding the steering and a target acceleration at as a target value regarding the vehicle speed based on the second trajectory ξ₂. In the present embodiment 1, the second trajectory ξ₂ includes a target steering angle δ_{t, k} and a target acceleration a_{t, k} in each prediction point k (k=0, . . . , N₂) , and the target value calculation unit 270 interpolates the target steering angle 67 _{t, k} and the target acceleration a_{t, k} for a time in accordance with a control cycle of each actuator, thereby calculating each of the target steering angle δₜ and the target acceleration aₜ.

In this manner, the target value calculation unit 270 calculates the target steering angle δₜ and the target acceleration at based on the second trajectory ξ₂ generated by the second trajectory generation unit 260 using the elaborate second vehicle model f₂, thus the elaborate vehicle control is achieved.

In Step S310 in FIG. 4, the actuator control unit 310 controls the actuator based on the target value calculated by the target value calculation unit 270. In the present embodiment 1, the EPS motor 5 is controlled so that steering angle δ follows the target steering angle δₜ, and the power train unit 6 and the brake unit 7 are controlled so that the acceleration a follows the target acceleration aₜ.

### Procedure of First Trajectory Generation

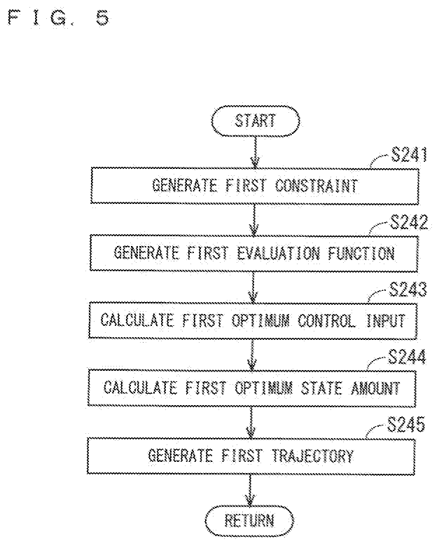

FIG. 5 is a flow chart illustrating an example of a procedure of a first trajectory generation according to the present embodiment 1. This process is performed in Step S240 in FIG. 4.

Firstly, in Step S241 in FIG. 5, the first trajectory generation unit 240 sets the first constraint g₁(x₁, u₁)≥0. In the present embodiment 1, the first constraint g_{1, k}, g_{1, N1} is set as the following expression so that the gravity position X_{g, k}, Y_{g, k} of the subject vehicle in each prediction point k (k=0, . . . , N₁) does not enter the no-entry region set in Step S230 and the first control input u_{1, k} is within a constant range. In the sentence in the present specification, a subscript letter of N₁is expressed as N1 for a notational constraint. According to the above setting, the first constraint g₁ includes a constraint of prohibiting the subject vehicle from entering the first place S₁.

$${ℊ}_{1 , k} = [ \begin{matrix}ζ ( {X}_{ℊ , k} , {Y}_{ℊ , k )} \\ {a}_{k} - \overline{a} \\ - {a}_{k} + \underline{a} \\ {ω}_{k} - \overline{ω} \\ - {ω}_{k} + \underline{ω}\end{matrix} ] ( k = 0 , … , {N}_{1} - 1 ) \qquad ( EXPRESSION 301 )$$

$${ℊ}_{1 , {N}_{1}} = ζ ( {X}_{ℊ , {N}_{1}} , {Y}_{ℊ , {N}_{1}} ) \qquad ( EXPRESSION 302 )$$

Herein, a, _a, ω, and _ω are an upper limit value and lower limit value of each control input, respectively. In the sentence in the present specification, a sign “_” expresses an under bar assigned to a subsequent letter, and a sign “ ” expresses an over bar assigned to a subsequent letter for a notational constraint. The upper limit value and the lower limit value of each control input may be changed for each prediction point k. In the present embodiment 1, the constraint is set on only the gravity position X_{g} and Y_{g} and the first control input u₁, however, the constraint may be set on a yaw rate and a lateral acceleration, for example, to improve ride quality.

In S 242 in FIG. 5, the first trajectory generation unit 240 sets the first evaluation value J₁ as with the expression 103. In the present embodiment 1, when the obstacle is not located in a horizon, the first vector value function h₁, h_{1, N1} regarding the evaluation item is set as the following expression so that the first trajectory generation unit 240 can generate the first trajectory for the subject vehicle to travel a reference path at a reference vehicle speed, and the control input at that time is reduced.

h₁=[e_{Y, k}, Vₖ, aₖ, ωₖ]^{T} (EXPRESSION 303)

h_{1,N}_{₁}=[e_{Y,N}_{₁}, V_{N}_{₁}]^{T} (EXPRESSION 304)

e_{Y, k} is a lateral deviation to a first reference path χ_{r, 1} in the prediction point k (k=0, . . . , N₁). When series data (X_{r, k}, Y_{r, k}, θ_{r, k}) of the first reference path χ_{r, 1} in the prediction point k (k=0, . . . , N₁) is provided, e_{Y, k} is expressed by the following expression.

e_{Y, k}=cos θ_{r,k}·(Y_{g,k}−Y_{r,k})−sin θ_{r,k}·(X_{g,k}−X_{r,k}) (EXPRESSION 305)

Herein, X_{r, k}, Y_{r, k}, and θ_{r, k} are a reference position in the X axis, a reference position in the Y axis, and the reference vehicle body orientation in the prediction point k (k=0, . . . , N₁), respectively. The reference values r_{1, k} and r_{1, N1} in the expression 103 are set as the following expressions.

r_{1,k}=[0, V_{r,k}, 0,0]^{T}(k=0, . . . , N₁−1) (EXPRESSION 306)

r_{1,N}_{₁}=[0, V_{r,N}_{₁}]^{T} (EXPRESSION 307)

According to the above setting, when the obstacle is not located in the horizon, the first trajectory generation unit 240 can generate the first trajectory for the subject vehicle to follow the first reference path at a reference vehicle speed with a small control input. The orientation, the yaw rate, and the lateral acceleration, for example, may be added to the evaluation item of the first evaluation function J₁ to improve followability and ride quality to the first reference path.

Described herein is an example of determining the reference position X_{r, k} and Y_{r, k}, the reference vehicle body orientation θ_{r, k}, and the reference vehicle speed V_{r, k} in the expression 305. Firstly, the first trajectory generation unit 240 determines the reference vehicle speed V_{r, k} based on a limited speed V₁ of a driving lane and a vehicle speed Vₚ of a preceding vehicle. For example, the first trajectory generation unit 240 determines V_{r, k}=V₁. V_{r, k} needs not have a constant value in the horizon. Next, the first trajectory generation unit 240 determines the reference position X_{r, k} and Yr_{r, k} and the reference vehicle body orientation θ_{r, k} based on the X position, the Y position, and the orientation of a center of the traffic lane indicated by the road information in a case of control for the subject vehicle to travel the center of the traffic lane, for example. Set between the reference position X_{r, k} and Y_{r, k} and the reference vehicle speed V_{r, k} is a condition for consistency therebetween. That is to say, the first trajectory generation unit 240 determines the reference position X_{r, k} and Y_{r, k} to satisfy the following two expressions.

Y_{r,k}=l(X_{r,k})(k=0, . . . N₁) (EXPRESSION 308)

\sqrt{(X_{r,k}−X_{r,k-1})²+(Y_{r,k}−Y_{r,k-1})²}=V_{r,k-1}·T_{s,1}(k=1, . . . N₁) (EXPRESSION 309)

The expression 308 is a condition that the reference position X_{r, k} and Y_{r, k} is located on the center of the traffic lane expressed by a function Y=1(X) of the expression 203. The expression 309 is a condition that an interval between the reference position X_{r, k-1} and Y_{r, k-1} and the reference position X_{r, k} and Y_{r, k} adjacent to each other is equal to a movement amount of the subject vehicle in the first prediction interval T_{s, 1}. The first trajectory generation unit 240 can also determine the reference vehicle body orientation θ_{r, k} by calculating the orientation of the traffic lane expressed by Y=1(X) in the reference position X_{r, k} and Y_{r, k} determined using the expression 308 and the expression 309.

In Step S243 in FIG. 5, the first trajectory generation unit 240 solves the optimization problem with constraint based on the first evaluation function J₁ of the expression 103 in which the road information and the first vehicle state amount x₁ are reflected and the first constraint g₁ of the expression 301 and the expression 302 in which the first place S₁ is reflected, thereby obtaining a first optimum control input u₁*. Used for a calculation of obtaining the first optimum control input u₁* is a known means such as an automatic control and dynamic optimization (ACADO) developed by K.U. Leuven university or AutoGen which is an automatic code generation tool for solving the optimization problem as a C/GMRES method base. When ACADO or AutoGen is used, in Step S243, the first trajectory generation unit 240 outputs the first optimum control input u₁* in the following expression which is time series data of the optimized control input in each prediction point k (k=0, . . . , N₁−1).

$${u}_{1}^{*} = [ \begin{matrix}{u}_{1 , 0}^{*} & ⋯ & {u}_{1 , {N}_{1} - 1}^{*}\end{matrix} ] = [ \begin{matrix}{a}_{1 , 0}^{*} & ⋯ & {a}_{1 , {N}_{1} - 1}^{*} \\ {ω}_{1 , 0}^{*} & ⋯ & {ω}_{1 , {N}_{1} - 1}^{*}\end{matrix} ] \qquad ( EXPRESSION 310 )$$

Herein, a_{1, k}* and ωa_{1, k}* of each prediction point k (k=0, . . . , N₁−1) are a first optimum acceleration and a first optimum steering angle speed. With regard to the solution, the first evaluation function J₁ may have a value lower than a predetermined threshold value as the solution, and when the value is not lower than the threshold value in a predetermined number of repetitions, a value minimizing the first evaluation function J₁ in the number of repetitions may be a solution.

In Step S244 in FIG. 5, the first trajectory generation unit 240 obtains the first optimum state amount x₁* which is time series data of the optimized first vehicle state amount x₁ in each prediction point k (k=0, . . . , N₁) based on the first optimum control input u₁* and the first vehicle model f₁. When the first optimum control input u₁* in the expression 310 is outputted, in Step S244, the first trajectory generation unit 240 outputs the first optimum state amount x₁* in the following expression.

$${x}_{1}^{*} = [ \begin{matrix}\begin{matrix}{x}_{1 , 0}^{*} & ⋯\end{matrix} & {x}_{1 , {N}_{1}}^{*}\end{matrix} ] = [ \begin{matrix}{X}_{ℊ , 1 , 0}^{*} & ⋯ & {X}_{ℊ , 1 , {N}_{1}}^{*} \\ {Y}_{ℊ , 1 , 0}^{*} & ⋯ & {Y}_{ℊ , 1 , {N}_{1}}^{*} \\ {θ}_{1 , 0}^{*} & ⋯ & {θ}_{1 , {N}_{1}}^{*} \\ {V}_{1 , 0}^{*} & ⋯ & {V}_{1 , {N}_{1}}^{*} \\ {δ}_{1 , 0}^{*} & ⋯ & {δ}_{1 , {N}_{1}}^{*}\end{matrix} ] \qquad ( EXPRESSION 311 )$$

Herein, X_{g, 1,k}* , Y_{g, 1,k}* , θ_{g, 1,k}* , V_{g, 1,k}* , and δ_{g, 1,k}* are a first optimum gravity position, a first optimum vehicle body orientation, a first optimum vehicle speed, and a first optimum steering angle in each prediction point k (k=0, . . . , N₁), respectively. Positional series data in the first optimum state amount x₁* is referred to as a first optimum path χ₁*. In the present embodiment 1, the first optimum path χ₁* is expressed by the following expression.

$${χ}_{1}^{*} = [ \begin{matrix}{X}_{ℊ , 1 , 0}^{*} & ⋯ & {X}_{ℊ , 1 , {N}_{1}}^{*} \\ {Y}_{ℊ , 1 , 0}^{*} & ⋯ & {Y}_{ℊ , 1 , {N}_{1}}^{*}\end{matrix} ] \qquad ( EXPRESSION 312 )$$

In Step S245 in FIG. 5, the first trajectory generation unit 240 generates the first trajectory ξ₁ based on the first optimum state amount x₁* and the first optimum control input u₁*. It is sufficient that the first trajectory ξ₁ includes the first optimum gravity position X_{g, 1}* and Y_{g, 1}*, the optimum vehicle body orientation θ₁*, and the optimum vehicle speed V₁*, however, in the present embodiment 1, the first optimum state amount x₁* is the first trajectory ξ₁. That is to say, in Step S245, the first trajectory generation unit 240 outputs the first trajectory ξ₁ in the following expression.

ξ₁=[ξ_{1,0} . . . ξ_{1,N}_{₁}]=[x*_{1,0} . . . x*_{1,N}_{₁}] (EXPRESSION 313)

Positional series data in the first trajectory ξ₁ is referred to as the first path χ₁. In the present embodiment 1, the first path χ₁ is expressed by the following expression.

$${χ}_{1}^{*} = [ \begin{matrix}{X}_{ℊ , 1 , 0}^{*} & ⋯ & {X}_{ℊ , 1 , {N}_{1}}^{*} \\ {Y}_{ℊ , 1 , 0}^{*} & ⋯ & {Y}_{ℊ , 1 , {N}_{1}}^{*}\end{matrix} ] \qquad ( EXPRESSION 314 )$$

### Procedure of Generating Second Trajectory

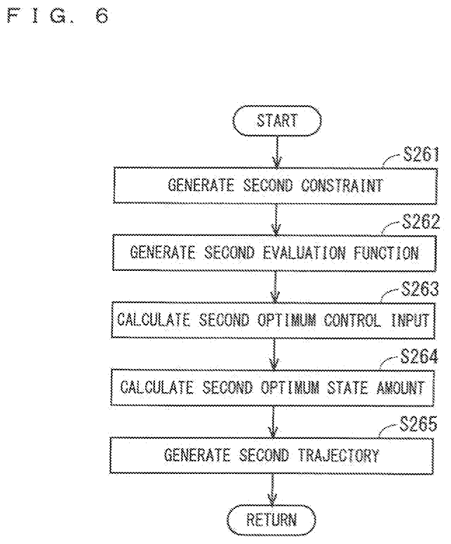

FIG. 6 is a flow chart illustrating an example of a procedure of a second trajectory generation according to the present embodiment 1. This process is performed in Step S260 in FIG. 4.

Firstly, in Step S261 in FIG. 6, the second trajectory generation unit 260 sets the second constraint g₂(x₂, u₂)≤0. In the present embodiment 1, the second constraint g_{2, k}, g_{2, N2} is set as the following expression so that the gravity position X_{g, k} and Y_{g, k} of the subject vehicle in each prediction point k (k=0, . . . , N₂) does not enter the no-entry region set in Step S250 and the second control input u_{2, k} is within a constant range. Accordingly, the second constraint g₂ includes a constraint of prohibiting the subject vehicle from entering the second place S₂.

$${ℊ}_{2 , k} = [ \begin{matrix}ζ ( {X}_{ℊ , k} , {Y}_{ℊ , k )} \\ {j}_{t , k} - {\overline{j}}_{t} \\ - {j}_{t , k} + \underline{{j}_{t}} \\ {ω}_{t , k} - \overline{ω} \\ - {ω}_{t , k} + \underline{ω}\end{matrix} ] ( k = 0 , … , {N}_{2} - 1 ) \qquad ( EXPRESSION 401 )$$

$${ℊ}_{2 , {N}_{2}} = ζ ( {X}_{ℊ , {N}_{2}} , {Y}_{ℊ , {N}_{2}} ) \qquad ( EXPRESSION 402 )$$

Herein, jₜ, _jₜ, ωₜ, and _ωₜ are an upper limit value and a lower limit value of each control input, respectively. The upper limit value and the lower limit value of each control input may be changed for each prediction point k. In the present embodiment 1, the constraint is set on only the gravity position X_{g} and Y_{g} and the second control input u₂, however, the constraint may be set on a yaw rate and a lateral acceleration, for example, to improve ride quality.

In S 262 in FIG. 6, the second trajectory generation unit 260 sets the second evaluation value J₂ as with the expression 103. In the present embodiment 1, the second vector value function h₂, h₂, N₂ regarding the evaluation item is set as the following expressions so that the second trajectory generation unit 260 can generate the second trajectory for the subject vehicle to follow the first path at a speed of the first trajectory and the control input at that time is reduced.

h₂=[e_{Y, k}, Vₖ, jₖ, ωₖ]^{T} (EXPRESSION 403)

h_{2,N}_{₂}=[e_{Y,N}_{₂}, V_{N}_{₂}]^{T} (EXPRESSION 404)

In the manner similar to the generation of the first trajectory, e_{Y, k} is a lateral deviation to a second reference path χ_{r, k} in the prediction point k (k=0, . . . , N₂) . When series data (X_{r, k}, Y_{r, k}, θ_{r, k}) of the second reference path χ_{r, 2} in the prediction point k (k=0, . . . , N₂) is provided, e_{Y, k} is expressed by the following expression.

e_{Y, k}=cos θ_{r,k}·(Y_{g,k}−Y_{r,k})−sin θ_{r,k}·(X_{g,k}−X_{r,k}) (EXPRESSION 505)

Herein, X_{r, k}, Y_{r, k}, and θ_{r, k} are a reference position in the X axis, a reference position in the Y axis, and the reference vehicle body orientation in the prediction point k (k=0, . . . , N₂) , respectively. The reference values r_{2, k} and r_{2, N2} in the expression 103 are set as the following expressions.

r_{2,k}=[0, V_{r,k}, 0,0]^{T}(k=0, . . . , N₂−1) (EXPRESSION 406)

r_{21,N}_{₂}=[0, V_{r,N}_{₂}]^{T} (EXPRESSION 407)

Herein, the second trajectory generation unit 260 uses a part of the first trajectory ξ₁ as the second reference path χ_{r, 2} for generating the second trajectory. In the present embodiment 1, the second trajectory generation unit 260 determines the reference position X_{r, k} and Y_{r, k}, the reference vehicle body orientation θ_{r, k}, and the reference vehicle speed V_{r, k} for each case so that the second reference path χ_{r, 2} is equal to the first path χ₁.

For example, when the first prediction interval T_{s, 1} and the second prediction interval T_{s, 2} are equal to each other, the second trajectory generation unit 260 determines the reference position X_{r, k} and Y_{r, k}, the reference vehicle body orientation θ_{r, k}, and the reference vehicle speed V_{r, k} as the following expression.

[X_{r,k}, Y_{r,k}, θ_{r,k}, V_{r,k}]^{T}=[X*_{g,1,k}, Y*_{g,1,k}, θ*_{g,1,k}, V*_{g,1,k}]^{T}(k=0, . . . , N₂) (EXPRESSION 408)

For example, when the first prediction interval T_{s, 2} and the second prediction interval T_{s, 2} are not equal to each other, the second trajectory generation unit 260 appropriately interpolates the time so that the interval between the first optimum gravity position X_{g, 1}* and Y_{g, 1}*, the optimum vehicle body orientation θ₁*, and the optimum vehicle speed V₁* coincides with the second prediction interval T_{s, 2} to determine the reference position X_{r, k} and Y_{r, k}, the reference vehicle body orientation θ_{r, k}, and the reference vehicle speed V_{r,k}.

According the above setting, the second trajectory generation unit 260 can generate the second trajectory for the subject vehicle to follow the first path at a speed of the first trajectory with a small control input. The orientation, the yaw rate, and the lateral acceleration, for example, may be added to the evaluation item of the second evaluation function J₂ to improve followability and ride quality to the first path.

In step S263 in FIG. 6, the second trajectory generation unit 260 solves the optimization problem with constraint based on the second evaluation function J₂ of the expression 103 in which the first trajectory and the second vehicle state amount x₂ are reflected and the second constraint g₂ of the expression 401 and the expression 402 in which the second place S₂ is reflected, thereby obtaining a second optimum control input u₂*. A method similar to the calculation of the first optimum control input can be used for the calculation of obtaining the second optimum control input u₂*. When ACADO or AutoGen is used, in Step S263, the second trajectory generation unit 260 outputs the second optimum control input u₂* in the following expression which is time series data of the optimized control input in each prediction point k (k=0, . . . , N₂−1).

$${u}_{2}^{*} = [ \begin{matrix}{u}_{2 , 0}^{*} & ⋯ & {u}_{2 , {N}_{2} - 1}^{*}\end{matrix} ] = [ \begin{matrix}{j}_{t , 2 , 0}^{*} & ⋯ & {j}_{t , 2 , {N}_{2} - 1}^{*} \\ {ω}_{t , 2 , 0}^{*} & ⋯ & {ω}_{t , 2 , {N}_{2} - 1}^{*}\end{matrix} ] \qquad ( EXPRESSION 409 )$$

The second trajectory generation unit 260 may determine an initial solution based on the first trajectory ξ₁ when the optimum problem is solved. The second trajectory ξ₂ and the first trajectory ξ₁ are similar to each other as long as the obstacle does not move significantly to deviate from the movement prediction, thus a speed of calculating the second optimum control input u₂* is improved by determining the initial solution based on the first trajectory ξ₁.

In Step S264 in FIG. 6, the second trajectory generation unit 260 obtains the second optimum state amount x₂* which is time series data of the optimized second vehicle state amount x₂ in each prediction point k (k=0, . . . , N₂) based on the second optimum control input u₂* and the second vehicle model f₂. When the second optimum control input u₂* in the expression 409 is outputted, in Step S264, the second trajectory generation unit 260 outputs the second optimum state amount x₂* in the following expression.

$${x}_{2}^{*} = [ \begin{matrix}\begin{matrix}{x}_{2 , 0}^{*} & ⋯\end{matrix} & {x}_{2 , {N}_{2}}^{*}\end{matrix} ] = [ \begin{matrix}{X}_{ℊ , 2 , 0}^{*} & ⋯ & {X}_{ℊ , 1 , {N}_{1}}^{*} \\ {Y}_{ℊ , 2 , 0}^{*} & ⋯ & {Y}_{ℊ , 1 , {N}_{1}}^{*} \\ {θ}_{2 , 0}^{*} & ⋯ & {θ}_{1 , {N}_{1}}^{*} \\ {β}_{2 , 0}^{*} & ⋯ & {β}_{2 , {N}_{2}}^{*} \\ {γ}_{2 , 0}^{*} & ⋯ & {γ}_{2 , {N}_{2}}^{*} \\ {V}_{1 , 0}^{*} & ⋯ & {V}_{1 , {N}_{1}}^{*} \\ {a}_{2 , 0}^{*} & ⋯ & {a}_{2 , {N}_{2}}^{*} \\ {a}_{t , 2 , 0}^{*} & ⋯ & {a}_{t , 2 , {N}_{2}}^{*} \\ {δ}_{2 , 0}^{*} & ⋯ & {δ}_{2 , {N}_{2}}^{*} \\ {δ}_{t , 2 , 0}^{*} & ⋯ & {δ}_{t , 2 , {N}_{2}}^{*}\end{matrix} ] \qquad ( EXPRESSION 410 )$$

Positional series data in the second optimum state amount x₂* is referred to as a second optimum path χ₂*. In the present embodiment 1, the second optimum path χ₂* is expressed by the following expression.

$${χ}_{2}^{*} = [ \begin{matrix}{X}_{ℊ , 2 , 0}^{*} & ⋯ & {X}_{ℊ , 2 , {N}_{2}}^{*} \\ {Y}_{ℊ , 2 , 0}^{*} & ⋯ & {Y}_{ℊ , 2 , {N}_{2}}^{*}\end{matrix} ] \qquad ( EXPRESSION 411 )$$

In Step S265 in FIG. 6, the second trajectory generation unit 260 generates the second trajectory ξ₂ based on the second optimum state amount x₂* and the second optimum control input u₂ *. It is sufficient that the second trajectory ξ₂ includes the second optimum steering angle δ₂* and the second optimum acceleration a₂*, however, in the present embodiment 1, the second optimum state amount x₂* is the second trajectory ξ₂. That is to say, in Step S265, the second trajectory generation unit 260 outputs the second trajectory ξ₂ in the following expression.

ξ₂=[ξ_{2,0} . . . ξ_{2,N}_{₂}]=[x*_{2,0} . . . x*_{2,N}_{₂}] (EXPRESSION 412)

Positional series data in the second trajectory ξ₂ is referred to as the second path χ₂. In the present embodiment 1, the second path χ₂ is expressed by the following expression.

$${χ}_{2}^{*} = [ \begin{matrix}{X}_{ℊ , 2 , 0}^{*} & ⋯ & {X}_{ℊ , 2 , {N}_{2}}^{*} \\ {Y}_{ℊ , 2 , 0}^{*} & ⋯ & {Y}_{ℊ , 2 , {N}_{2}}^{*}\end{matrix} ] \qquad ( EXPRESSION 413 )$$

### Conclusion of Embodiment 1

According to the control calculation apparatus 201 of the present embodiment 1 described above, the degree of the second vehicle model f₂ is larger than that of the first vehicle model f₁.

According to such a configuration, the trajectory is generated from the elaborate second vehicle model f₂ based on the trajectory generated from the simple first vehicle model f₁, thus calculation load by the elaborate vehicle model f₂ can be reduced.

When the second prediction period T_{h, 2} is smaller than the first prediction period T_{h, 1}, the long-period trajectory can be generated from the simple first vehicle model f₁, and the short-period trajectory can be generated from the elaborate second vehicle model f₂. Thus, both generation of the smooth trajectory along which the subject vehicle can smoothly travel and elaborate control of the subject vehicle can be achieved while suppressing increase in the calculation load.

### Embodiment 2

A block diagram of the control calculation apparatus 201 according to the present embodiment 2 is similar to that in FIG. 1. The same or similar reference numerals as those in the embodiment 1 will be assigned to the same or similar constituent elements according to the embodiment 2, and the different constituent elements are mainly described hereinafter. The same applies to the embodiment 2 and subsequent embodiments.

In the embodiment 1, the second place may be the same as or different from the first place, however in the present embodiment 2, the second place is different from the first place.

### Relationship Between First Place, First Path, Second Place, and Second Path

Described is a relationship between the first place, the first path, the second place, and the second path. Described firstly is a relationship between the first place and the first path.

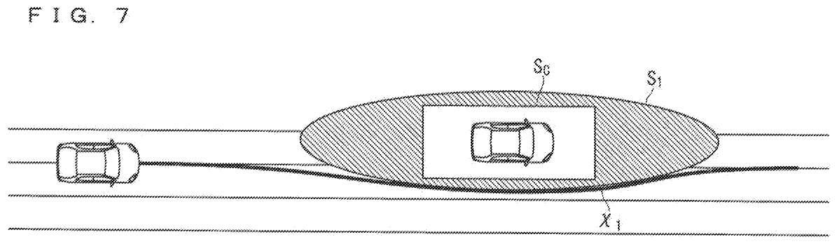

FIG. 7 is a schematic view illustrating an example of a relationship between the first place S₁ and the first path χ₁ according to the present embodiment 2. In the example in FIG. 7, a preceding vehicle as an obstacle on the front left side stops or travels in parallel to the traffic lane while the subject vehicle travels a straight road. Considered in this case is that the subject vehicle travels a center of the traffic lane as much as possible while avoiding the obstacle. A condition that the traffic lane is the straight road is an example, thus the traffic lane may not be the straight road. In the example in FIG. 7, the number of the traffic lane is three, however, this configuration is not necessary.

The first place setting unit 230 sets the first place S₁ including the oval no-entry region by the method described in Step S230 based on the position Xₒ and Yₒ of the center P_{C} of the obstacle and the vehicle body orientation θₒ acquired by the obstacle information acquisition unit 110. A long axis a and a short axis of the oval are set so as to include a collision region S_{C} where the subject vehicle collides with the obstacle when a gravity of the subject vehicle enters, for example. When the first place S₁ is set in this manner, the first trajectory generation unit 240 generates a path in which the subject vehicle does not enter the first place S₁ and is not away from the center of the traffic lane as much as possible as illustrated in FIG. 7 as the first path χ₁.

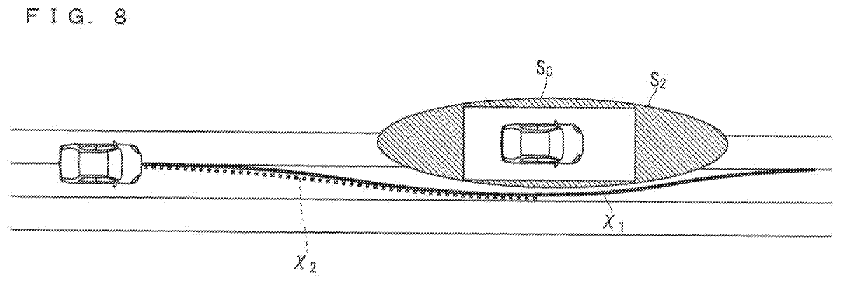

Described next is a relationship among the first path χ₁, the second place S₂, and the second path χ₂. FIG. 8 is a schematic view illustrating an example of a relationship among the first path χ₁, the second place S₂, and the second path x₂ according to the present embodiment 2.

The second place setting unit 250 sets the second place S₂ including an oval no-entry region by the method described in Step S250 based on peripheral information. For example, the second place setting unit 250 sets the second place S₂ including the collision region S_{c} and having the oval with a long axis a and a short axis b smaller than the first place S₁ so that the second place S₂ is not overlapped with the first path χ₁ as much as possible. Then, in Step S262, the second trajectory generation unit 260 sets the first path χ₁ as the second reference path X_{r, 2}.

The second place S₂ is smaller than the first place S₁, thus the first path χ₁ as the second reference path X_{r, 2} is not overlapped with the second place S₂ as long as the obstacle does not move significantly to deviate from the movement prediction until the processing of the second trajectory generation unit 260 is started after the processing of the first trajectory generation unit 240 is completed. In this case, reduced is a possibility that the second optimum control input obtained as the solution of the optimum problem by the second trajectory generation unit 260 in Step S263 conflicts with the constraint by the second place S₂, thus a calculation speed in the second optimum control input by the second trajectory generation unit 260 is improved. In this case, as illustrated in FIG. 8, there is a case where the second path x₂ is substantially the same as the first path χ₁, thus increase in the calculation load of the second trajectory generation unit 260 using the elaborate second vehicle model f₂ can be suppressed. The second path x₂ acquired in Step S265 is a path reflecting vehicle movement of the second vehicle model f₂ while following the first path χ₁ as illustrated in FIG. 8.

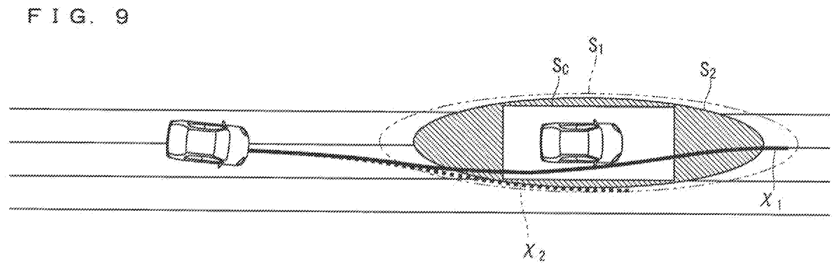

FIG. 9 is a schematic view illustrating another example of the relationship among the first path χ₁, the second place S₂, and the second path x₂ according to the present embodiment 2. FIG. 9 illustrates a state where the obstacle moves significantly to deviate from the movement prediction until the processing of the second trajectory generation unit 260 is started after the processing of the first trajectory generation unit 240 illustrated in FIG. 7 is completed.

Such a state may occur when the first execution period T_{e, 1} is larger than the second execution period T_{e, 2} and the first execution period T_{e, 1} is long such as one second, or when accuracy of a sensor of the obstacle information acquisition unit 110 is low, for example.

In the example in FIG. 9, the obstacle moves significantly to deviate from the movement prediction, thus when the subject vehicle follows the first path χ₁, it collides with the obstacle. However, when the second place S₂ is set, a path in which the subject vehicle does not enter the second place S₂ can be acquired as the second path χ₂, thus collision of the subject vehicle with the obstacle can be avoided even in a state as illustrated in FIG. 9, and safety can be ensured.

A portion where the second place S₂ and the first path χ₁ of the first trajectory ξ₁ are overlapped with each other is smaller than a portion where the first place S₁ and the first path χ₁ of the first trajectory S₁ are overlapped with each other, thus increase in the calculation load of the second trajectory generation unit 260 using the elaborate second vehicle model f₂ can be suppressed. As illustrated in FIG. 9, the first path χ₁ is considered at the time of calculating the second path χ₂, thus the deviation between the second path χ₂ and the first path χ₁ can be reduced as much as possible, and increase in the calculation load of the second trajectory generation unit 260 can be suppressed.

The state where the portion where the second place S₂ and the first path χ₁ of the first trajectory ξ₁ are overlapped with each other is smaller than the portion where the first place S₁ and the first path χ₁ of the first trajectory χ₁ are overlapped with each other may or may not include a state where the second place S₂ and the first path χ₁ are not overlapped with each other. When the portion where the second place S₂ and the first path χ₁ are overlapped with each other is smaller than the portion where the first place S₁ and the first path χ₁ are overlapped with each other, the second place S₂ needs not be smaller than the first place S₁. For example, the second place S₂ may be a place where the first place S₁ is moved in a travel direction of the subject vehicle while maintaining an area thereof in an XY plane.

### Embodiment 3

In the embodiment 2, the second place setting unit 250 sets the second place S₂ so that the portion where the second place S₂ and the first path χ₁ are overlapped with each other is smaller than the portion where the first place S₁ and the first path χ₁ are overlapped with each other. In contrast, in the present embodiment 3, the second place setting unit 250 sets the second place S₂ so that the portion where the second place S₂ and the first path χ₁ are overlapped with each other is larger than the portion where the first place S₁ and the first path χ₁ are overlapped with each other.

Accordingly, when the trajectory is generated by the first trajectory generation unit 240 and the second trajectory generation unit 260, the difference between the reference path and the optimum path is reduced, thus the calculation load in generating each trajectory can be reduced. The difference between the reference path and the optimum path is small, thus a possibility of occurrence of a local optimum solution can also be reduced. When linearization is performed around an initial solution in the optimum calculation, linearization error can be reduced by setting a reference path having a small difference from the optimum path as the initial solution.

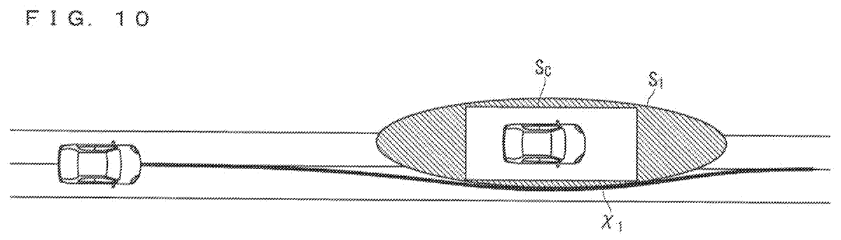

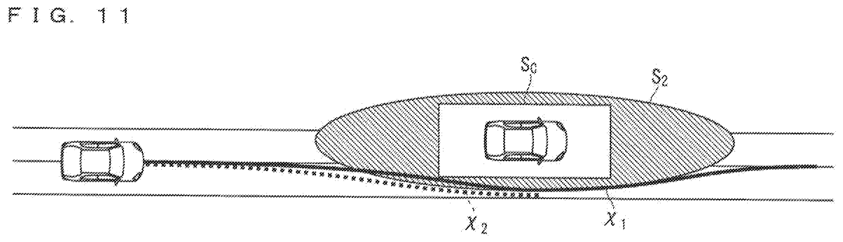

FIG. 10 is a schematic view illustrating an example of a relationship between the first place S₁ and the first path χ₁ according to the present embodiment 3. FIG. 11 is a schematic view illustrating an example of a relationship among the first path χ₁, the second place S₂, and the second path χ₂ according to the present embodiment 3.

As illustrated in FIG. 10, the first place setting unit 230 sets the first place S₁ having a minimal size to be able to include the collision region S_{C} . The first place S₁ is set to be small, thus a difference of the first path χ₁ from the center of the traffic lane as the reference path is reduced. Accordingly, reduction in the calculation load, reduction in a possibility of occurrence of the local optimum solution, and reduction in the linearization error in the first trajectory generation unit 240 can be achieved. However, there is little room in an interval between the subject vehicle and the obstacle (that is to say, avoidance interval) at the time of avoiding the obstacle, thus there is a possibility that the subject vehicle cannot avoid the obstacle only by such a configuration.

Thus, as illustrated in FIG. 11, the second place setting unit 250 sets the second place S₂ larger than the first place S1. The first path xi includes little room for the avoidance interval, however, the second path x₂ includes a room for the avoidance interval, thus the safety is improved. The second trajectory generation unit 260 sets the first path χ₁ as the second reference path X_{r, 2}, thus the difference between the reference path and the optimum path is reduced compared with a case where the center of the traffic lane is set as the reference path. Accordingly, reduction in the calculation load in the second trajectory generation, reduction in a possibility of occurrence of the local optimum solution, and reduction in the linearization error in the second trajectory generation can be achieved.

### Embodiment 4

In the embodiment 2, the first place S1 is the no-entry region for the obstacle, however, the configuration is not limited thereto. In the present embodiment 4, the first place S₁ may be a potential field of risk in accordance with a degree of proximity corresponding to a distance from a center of the first place to the subject vehicle. The center of the first place herein may be a center point, an obstacle, or a no-entry region.

In the present embodiment 4, a variable of the first evaluation function J₁ includes a degree of proximity corresponding to a distance from the center of the first place S₁ to the subject vehicle e.g. a parameter relating to a potential field such as repulsion force corresponding to the distance, for example. Accordingly, the constraint on the position for avoiding the obstacle is reduced in the constraint used in the first trajectory generation unit 240, thus a possibility of seeking the optimum solution is improved. However, an avoidance interval between the subject vehicle and the obstacle cannot be clearly designated in the first trajectory generation unit 240 at the time of avoiding the obstacle, thus there is a possibility that the subject vehicle cannot avoid the obstacle only by such a configuration. Thus, in the present embodiment 4, the no-entry region is used for the second place S₂. The avoidance interval can be clearly designated in the second trajectory generation unit 260, thus the subject vehicle can reliably avoid the obstacle.

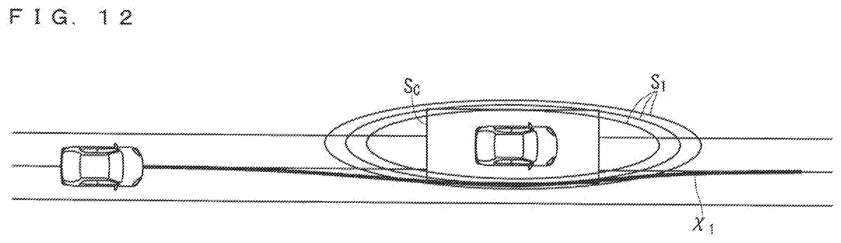

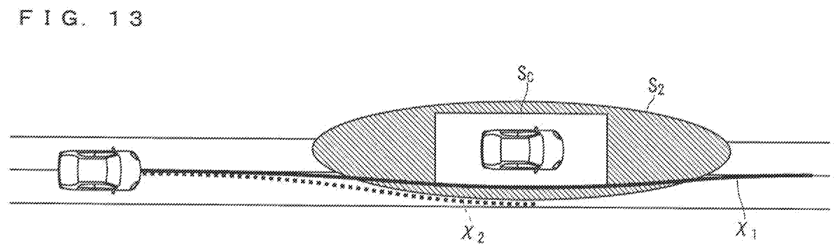

FIG. 12 is a schematic view illustrating an example of a relationship between the first place S₁ and the first path χ₁ according to the present embodiment 4. FIG. 13 is a schematic view illustrating an example of a relationship among the first path χ₁, the second place S₂, and the second path χ₂ according to the present embodiment 4.

As illustrated in FIG. 12, the first place S₁ is a potential field of risk in accordance with a degree of proximity with respect to the obstacle. Accordingly, the constraint on the position for avoiding the obstacle is reduced in generating the first trajectory, thus a possibility of seeking the optimum solution is improved. However, the avoidance interval cannot be clearly designated in the first trajectory generation unit 240, thus there is a possibility that the subject vehicle cannot avoid the obstacle depending on a design of the first evaluation function J₁.

Thus, as illustrated in FIG. 13, the second place setting unit 250 sets the second place S₂ to include the collision region S_{C}. The avoidance interval can be clearly designated in the second trajectory generation unit 260, thus the subject vehicle can reliably avoid the obstacle. The second trajectory generation unit 260 sets the first path χ₁ as the second reference path X_{r, 2}, thus the difference between the reference path and the optimum path is reduced compared with a case where the center of the traffic lane is set as the reference path. Accordingly, reduction in the calculation load in the second trajectory generation, reduction in a possibility of occurrence of the local optimum solution, and reduction in the linearization error in the second trajectory generation can be achieved.

When the first evaluation function J₁ is designed so that the subject vehicle can sufficiently avoid the obstacle, a variable of the second evaluation function J₂ may include a degree of proximity corresponding to a distance from the center of the second place S₂ to the subject vehicle in the manner similar to the first evaluation function J₁.

### Embodiment 5

In the embodiment 2, the first place S1 and the second place S₂ are set for the obstacle, however, they may be set for a boundary part of a road. In this case, the second place S₂ of the boundary part of the road is set in the manner similar to the second place S₂ of the obstacle. In the present embodiment 5, the first place S₁ is larger than a region of at least one of the obstacle and/or the road, and the second place S₂ is equal to or larger than the region of at least one of the obstacle and/or the road, and is smaller than the first place S₁. Accordingly, the first path χ₁ as the reference path of the second trajectory generation unit 260 is not overlapped with the second place S₂, and reduced is a possibility that a solution of the optimum problem by the second trajectory generation unit 260 conflicts with the constraint by the second place S₂, thus the calculation load of the second trajectory generation unit 260 can be reduced.

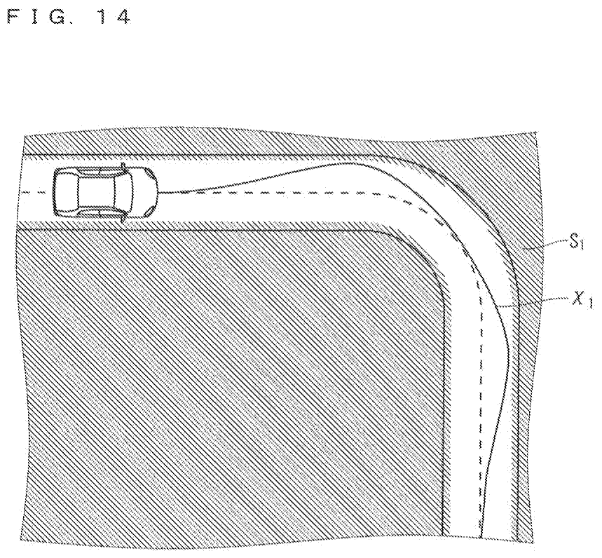

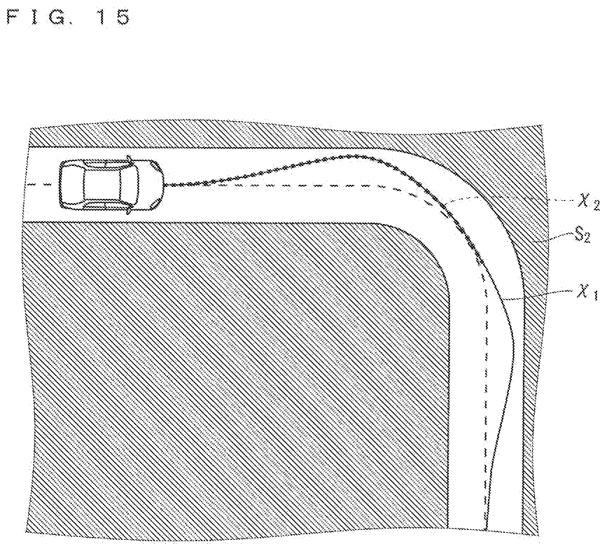

FIG. 14 is a schematic view illustrating an example of a relationship between the first place S₁ and the first path χ₁ according to the present embodiment 5. FIG. 15 is a schematic view illustrating an example of a relationship among the first path χ₁, the second place S₂, and the second path x₂ according to the present embodiment 5.

In FIG. 14, the first place S₁ is set to the no-entry region for the boundary part of the road. However, the first place S₁ is set to be slightly larger than the boundary part of the road.

In FIG. 15, the second place S₂ is set to the no-entry region for the boundary part of the road. However, the second place S₂ is a region of the road, and is set to be smaller than the first place S₁. Accordingly, the first path χ₁ as the reference path of the second trajectory generation unit 260 is not overlapped with the first place S₂, and reduced is a possibility that a solution of the optimum problem by the second trajectory generation unit 260 conflicts with the constraint by the second place S₂, thus the calculation load of the second trajectory generation unit 260 can be reduced.

### Embodiment 6

The embodiments 2 and 5 describe reduction in a possibility that a solution of the optimum problem by the second trajectory generation unit 260 conflicts with the constraint by the second place S₂. This is achieved by appropriately setting the second place S₂. Described in the present embodiment 6 is a method of setting the first constraint g₁ in generating the first trajectory and the second constraint g₂ in generating the second trajectory.

In the present embodiment 6, the constraint may be set not only on the position of the subject vehicle and the control input but also on the speed, the lateral acceleration, the steering angle, and the yaw rate, for example, in the manner similar to the other embodiments. Then, the second constraint g₂ is set to be looser than the first constraint g₁. For example, upper-lower limit values ₁ and _₁ are set for the steering angle δ in the first constraint g₁. In the similar manner, upper-lower limit values ₂ and _₂ are set for the steering angle δ in the second constraint g₂. At this time, a minutely small amount is ε(>0), and ₂=_₁+ε and ₂=_₁−ε are defined, thus the second constraint regarding the steering angle δ is looser than the first constraint. The second constraint is set in the similar manner not only on the steering angle δ but also on the other vehicle state amount, thus there is a low possibility that the first trajectory generated by the first trajectory generation unit 240 conflicts with the second constraint g₂. Accordingly, when the second trajectory generation unit 260 generates the second trajectory, there is a low possibility that the second trajectory conflicts with the second constraint g₂, thus the calculation load in generating the second trajectory can be reduced.

### Another Modification Example

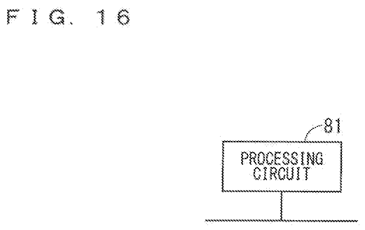

The first place setting unit 230, the first trajectory generation unit 240, the second place setting unit 250, the second trajectory generation unit 260, and the target value calculation unit 270 in FIG. 1 described above are referred to as “the first place setting unit 230 etc.” hereinafter. The first place setting unit 230 etc. is achieved by a processing circuit 81 illustrated in FIG. 16. That is to say, the processing circuit 81 includes: the first place setting unit 230 setting the first place where the vehicle does not travel based on the peripheral information; the first trajectory generation unit 240 generating the first trajectory of the vehicle in the first prediction period based on the first vehicle model expressing movement of the vehicle and the first place; the second place setting unit 250 setting the second place, different from the first place, where the vehicle does not travel based on the peripheral information; the second trajectory generation unit 260 generating the second trajectory of the vehicle in the second prediction period equal to or shorter than the first prediction period based on the second vehicle model expressing movement of the vehicle and having the degree larger than the degree of the first vehicle model, the second place, and the first trajectory; and the target value calculation unit 270 calculating and outputting the target value for controlling the vehicle based on the second trajectory. Dedicated hardware may be applied to the processing circuit 81, or a processer executing a program stored in a memory may also be applied. Examples of the processor include a central processing unit, a processing device, an arithmetic device, a microprocessor, a microcomputer, or a digital signal processor (DSP).

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. Each function of the first place setting unit 230 etc. may be achieved by circuits to which the processing circuit is dispersed, or each function of them may also be collectively achieved by one processing circuit.

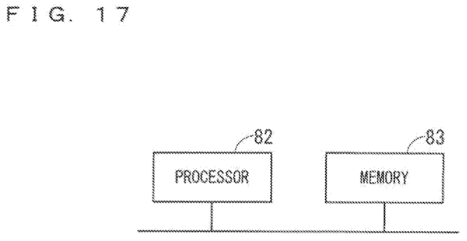

When the processing circuit 81 is the processor, the functions of the first place setting unit 230 etc. are achieved by a combination with software etc. Software, firmware, or software and firmware, for example, fall under the software etc. The software etc. is described as a program and is stored in a memory. As illustrated in FIG. 17, a processor 82 applied to the processing circuit 81 reads out and executes a program stored in the memory 83, thereby achieving the function of each unit. That is to say, the control calculation apparatus 201 includes the memory 83 for storing a program resultingly executing: a step of setting the first place where the vehicle does not travel based on the peripheral information; a step of generating the first trajectory of the vehicle in the first prediction period based on the first vehicle model expressing movement of the vehicle and the first place; a step of setting the second place, different from the first place, where the vehicle does not travel based on the peripheral information; a step of generating the second trajectory of the vehicle in the second prediction period equal to or shorter than the first prediction period based on the second vehicle model expressing movement of the vehicle and having the degree larger than the degree of the first vehicle model, the second place, and the first trajectory; and a step of calculating and outputting the target value for controlling the vehicle based on the second trajectory. In other words, this program is also deemed to make a computer execute a procedure or a method of the first place setting unit 230 etc. Herein, the memory 83 may be a non-volatile or volatile semiconductor memory such as a RAM, a ROM, a flash memory, an erasable programmable read only memory

(EPROM), or an electrically erasable programmable read only memory (EEPROM), a hard disk drive (HDD), a magnetic disc, a flexible disc, an optical disc, a compact disc, a mini disc, a digital versatile disc (DVD), or a drive device of them, or any storage medium which is to be used in the future, for example.

Described above is the configuration that each function of the first place setting unit 230 etc. is achieved by one of the hardware and the software, for example. However, the configuration is not limited thereto, but also applicable is a configuration of achieving a part of the first place setting unit 230 etc. by dedicated hardware and achieving another part of them by software, for example. For example, the function of the first place setting unit 230 can be achieved by the processing circuit 81 as the dedicated hardware, an interface, and a receiver, for example, and the function of the other units can be achieved by the processing circuit 81 as the processor 82 reading out and executing the program stored in the memory 83.

As described above, the processing circuit 81 can achieve each function described above by the hardware, the software, or the combination of them, for example.

The control calculation apparatus described above can also be applied to a control calculation system constituted as a system by appropriately combining a vehicle apparatus such as a portable navigation device (PND), a navigation device, and a driver monitoring system (DMS), a communication terminal including a mobile terminal such as a mobile phone, a smartphone, and a tablet, a function of an application installed in at least one of the vehicle apparatus and/or the communication terminal, and a server. In this case, each function or each constituent element of the control calculation apparatus described above may be dispersedly disposed in each apparatus constructing the system, or may also be collectively disposed in one of the apparatuses.

Each embodiment and each modification example can be arbitrarily combined, or each embodiment and each modification example can be appropriately varied or omitted.

The foregoing description is in all aspects illustrative and does not restrict the invention. It is therefore understood that numerous modification examples can be devised.

### EXPLANATION OF REFERENCE SIGNS

1 subject vehicle, 201 control calculation apparatus, 230 first place setting unit, 240 first trajectory generation unit, 250 second place setting unit, 260 second trajectory generation unit, 270 target value calculation unit.

1. A control calculation apparatus, comprising:
first place setting circuitry setting a first place where a vehicle does not travel based on peripheral information around the vehicle;
first trajectory generation circuitry generating a first trajectory of the vehicle in a first prediction period based on a first vehicle model expressing movement of the vehicle and the first place;
second place setting circuitry setting a second place, different from the first place, where the vehicle does not travel based on the peripheral information;
second trajectory generation circuitry generating a second trajectory of the vehicle in a second prediction period equal to or shorter than the first prediction period based on a second vehicle model expressing movement of the vehicle and having a degree larger than a degree of the first vehicle model, the second place, and the first trajectory; and
target value calculation circuitry calculating and outputting a target value for controlling the vehicle based on the second trajectory.

2. The control calculation apparatus according to claim 1, wherein
the first prediction period is a product of a total number of prediction points and a first prediction interval,
the second prediction period is a product of a total number of prediction points and a second prediction interval, and
the first prediction interval is equal to or larger than the second prediction interval.

3. The control calculation apparatus according to claim 1, wherein
the first trajectory generation circuitry generates the first trajectory in a first execution period, and
the second trajectory generation circuitry generates the second trajectory in a second execution period equal to or shorter than the first execution period.

4. The control calculation apparatus according to claim 1, wherein
the first trajectory generation circuitry generates the first trajectory based on the first vehicle model, the first place, a first evaluation function, and a first constraint.

5. The control calculation apparatus according to claim 1, wherein
the second trajectory generation circuitry generates the second trajectory based on the second vehicle model, the second place, a second evaluation function, a second constraint, and the first trajectory.

6. The control calculation apparatus according to claim 1, wherein
the first trajectory generation circuitry generates the first trajectory based on the first vehicle model, the first place, a first evaluation function, and a first constraint, and
the second trajectory generation circuitry generates the second trajectory based on the second vehicle model, the second place, a second evaluation function, a second constraint, and the first trajectory.

7. The control calculation apparatus according to claim 1, wherein
the second trajectory generation circuitry uses at least a part of the first trajectory as a reference path to generate the second trajectory.

8. The control calculation apparatus according to claim 4, wherein
the first constraint includes a constraint of prohibiting the vehicle from entering the first place.

9. The control calculation apparatus according to claim 5, wherein
the second constraint includes a constraint of prohibiting the vehicle from entering the second place.

10. The control calculation apparatus according to claim 1, wherein
a portion where the second place and the first trajectory are overlapped with each other is smaller than a portion where the first place and the first trajectory are overlapped with each other.

11. The control calculation apparatus according to claim 1, wherein
a portion where the second place and the first trajectory are overlapped with each other is larger than a portion where the first place and the first trajectory are overlapped with each other.

12. The control calculation apparatus according to claim 4, wherein
a variable of the first evaluation function includes a degree of proximity corresponding to a distance from a center of the first place to the vehicle.

13. The control calculation apparatus according to claim 5, wherein
a variable of the second evaluation function includes a degree of proximity corresponding to a distance from a center of the second place to the vehicle.

14. The control calculation apparatus according to claim 6, wherein
the second constraint is looser than the first constraint.

15. A control calculation method, comprising:
setting a first place where a vehicle does not travel based on peripheral information around the vehicle;
generating a first trajectory of the vehicle in a first prediction period based on a first vehicle model expressing movement of the vehicle and the first place;
setting a second place, different from the first place, where the vehicle does not travel based on the peripheral information;
generating a second trajectory of the vehicle in a second prediction period equal to or shorter than the first prediction period based on a second vehicle model expressing movement of the vehicle and having a degree larger than a degree of the first vehicle model, the second place, and the first trajectory; and
calculating and outputting a target value for controlling the vehicle based on the second trajectory.
